(19) United States
(12) Patent Application Publication
(10) Pub. No.: US 2024/0316958 A1
(43) Pub. Date: Sep. 26, 2024

(54) PRINTING APPARATUS

(71) Applicant: Daiki ETO, Kanagawa (JP)

(72) Inventor: Daiki ETO, Kanagawa (JP)

(21) Appl. No.: 18/613,190

(22) Filed: Mar. 22, 2024

(30) Foreign Application Priority Data
Mar. 24, 2023 (JP) 2023-048105
Mar. 5, 2024 (JP) 2024-033222

(51) Int. Cl. B41J 11/06; B41J 11/14

(52) U.S. Cl. CPC B41J 11/06; B41J 11/14

(57) ABSTRACT

A printing apparatus includes a first support and a second support to support a printing object. The first support has a first flat surface to support the printing object, and includes a plurality of positioning portions at a plurality of positions of the first flat surface. The second support has a second flat surface to support the printing object, and includes a positioned portion to be positioned on any one of the plurality of positioning portions of the first support, with the second flat surface being higher than the first flat surface.

### CROSS-REFERENCE TO RELATED APPLICATIONS

This patent application is based on and claims priority pursuant to 35 U.S.C. § 119(a) to Japanese Patent Application Nos. 2023-048105, filed on Mar. 24, 2023, and 2024-033222, filed on Mar. 5, 2024, in the Japan Patent Office, the entire disclosures of which are hereby incorporated by reference herein.

### BACKGROUND

### Technical Field

Embodiments of the present disclosure relate to a printing apparatus including a first support and a second support capable of supporting an object to be printed.

### Related Art

As a printing apparatus, for example, a textile printing apparatus that performs printing on a cloth or fabric such as a T-shirt is known. In the textile printing apparatus, the objects to be printed, such as T-shirts, socks, and handkerchiefs, do not necessarily have a constant shape or size, and may have raised portions on the cloth surface, such as pockets or buttons. Therefore, when a printing object is set on a supporting member (platen), the printing object may be wrinkled and the raised portions may cause a printing failure.

### SUMMARY

According to an embodiment of the present disclosure, a printing apparatus includes a first support and a second support to support a printing object. The first support has a first flat surface to support the printing object, and includes a plurality of positioning portions at a plurality of positions of the first flat surface. The second support has a second flat surface to support the printing object. The second support includes a positioned portion to be positioned to any one of the plurality of positioning portions with the second flat surface being higher than the first flat surface.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1A is a perspective view of a printing apparatus according to a first embodiment of the present disclosure;

FIG. 1B is a plan view of the printing apparatus according to the first embodiment;

FIG. 1C is a front view of the printing apparatus according to the first embodiment;

FIG. 2A is a plan view of a first platen;

FIG. 2B is a schematic plan view of the first platen;

FIG. 2C-A is a schematic plan view of the first platen;

FIG. 2C-B is a perspective view of a second platen;

FIG. 2C-C is a cross-sectional view of the second platen;

FIG. 2D-A is a plan view of a T-shirt;

FIG. 2D-B is a plan view of the T-shirt set on the first platen and the second platen;

FIG. 2E-A is a diagram illustrating an operation screen of the printing apparatus;

FIG. 2E-B is a block diagram illustrating a hardware configuration of a controller of the printing apparatus;

FIG. 2F-A is a plan view of the second platen mounted on the first platen and a one-point image to be printed;

FIG. 2F-B is a conceptual diagram illustrating print data written in a print job;

FIG. 2F-C is a conceptual diagram illustrating a print region written in a print job;

FIG. 2G-A is a plan view of a height sensor and the first platen, illustrating an initial state of height detection of the second platen by the height sensor;

FIG. 2G-B is a plan view of the height sensor and the first platen, illustrating a height sensing state of the second platen by the height sensor;

FIG. 2G-C is a plan view of the height sensor and the first platen, illustrating a state of raising the first platen;

FIG. 2G-D is a plan view of the height sensor and the first platen, illustrating a state of foreign object detection and printing start;

FIG. 2H including FIG. 2H-A and FIG. 2H-B is a flowchart of a printing process;

FIG. 3A is a front view of a first platen of a printing apparatus according to a second embodiment of the present disclosure;

FIG. 3B is a perspective view of a second platen of the printing apparatus according to the second embodiment;

FIG. 3C is a side view of the second platen of the printing apparatus according to the second embodiment;

FIG. 3D is a front view of the second platen fitted to the first platen of the printing apparatus according to the second embodiment;

FIG. 3E-A is a plan view of the printing apparatus according to the second embodiment, in which the first platen and the second platen are disposed;

FIG. 3E-B is a plan view of the printing apparatus according to the second embodiment, in a state where socks are set on the second platen;

FIG. 4A is a plan view of a first platen of a printing apparatus according to a third embodiment of the present disclosure;

FIG. 4B is a perspective view of a second platen of the printing apparatus according to the third embodiment;

FIG. 4C is a front view of the second platen mounted on the first platen according to the third embodiment;

FIG. 5A is a plan view of a first platen of a printing apparatus according to a fourth embodiment of the present disclosure;

FIG. 5B is a perspective view of a second platen of the printing apparatus according to the fourth embodiment;

FIG. 6A is a plan view of a first platen of a printing apparatus according to a fifth embodiment of the present disclosure;

FIG. 6B is a perspective view of a second platen, as viewed from obliquely above, of the printing apparatus according to the fifth embodiment;

FIG. 6C is a perspective view of the second platen, as viewed from obliquely below, of the printing apparatus according to the fifth embodiment; and

FIG. 6D is a front view of the second platen mounted on the first platen according to the fifth embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Referring now to the drawings, wherein like reference numerals designate identical or corresponding parts throughout the several views, embodiments of the present disclosure are described below. Note that identical parts are given identical reference numerals and redundant descriptions may be summarized or omitted accordingly.

### First Embodiment

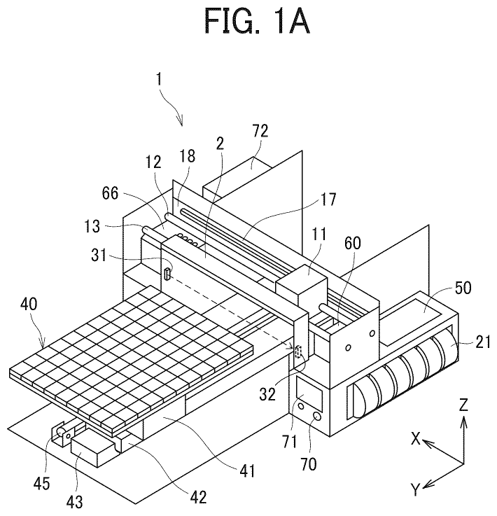

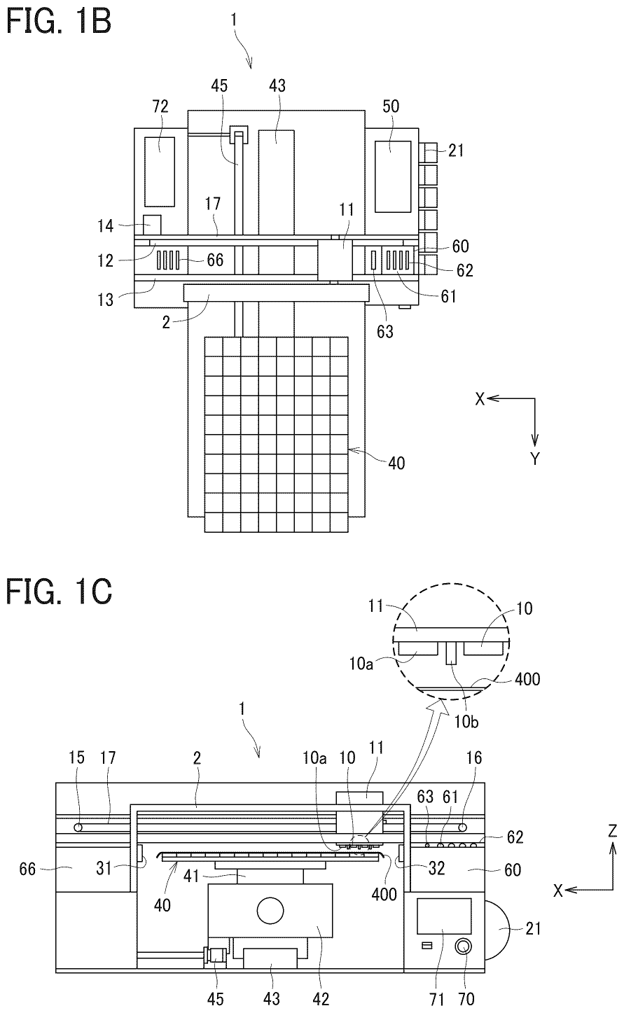

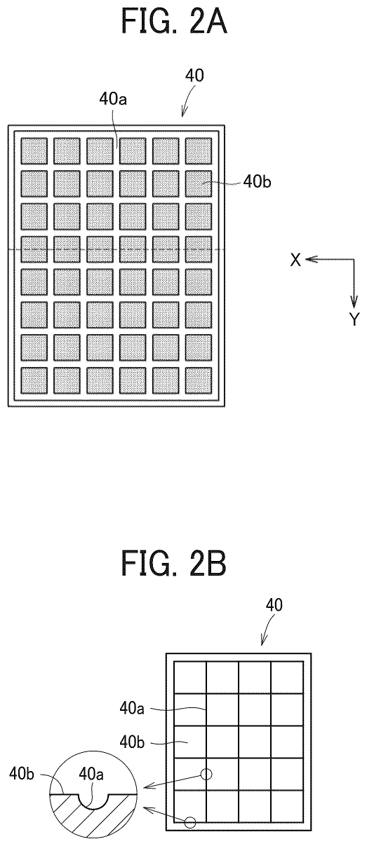

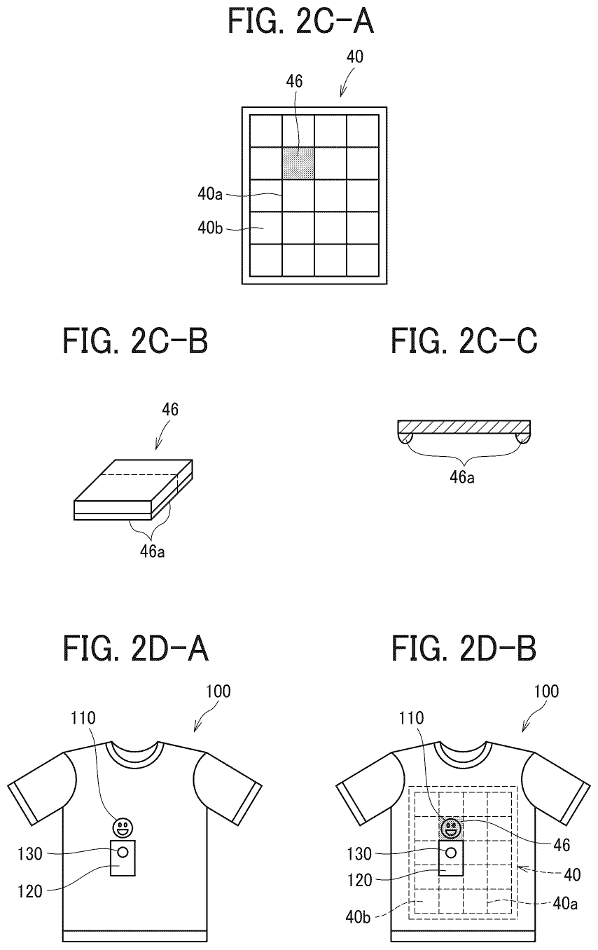

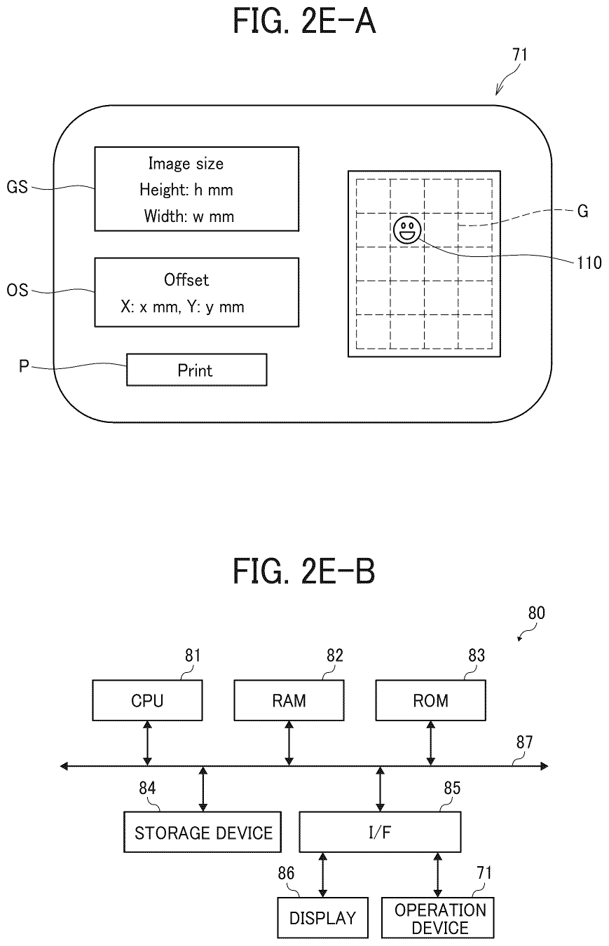

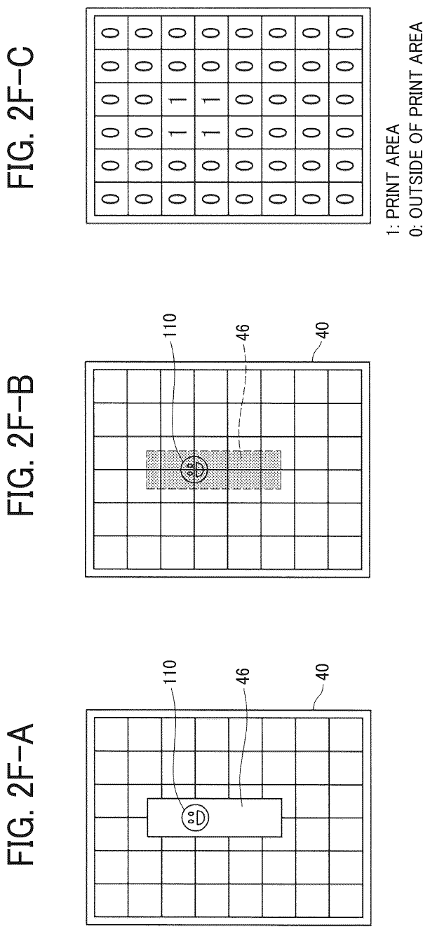

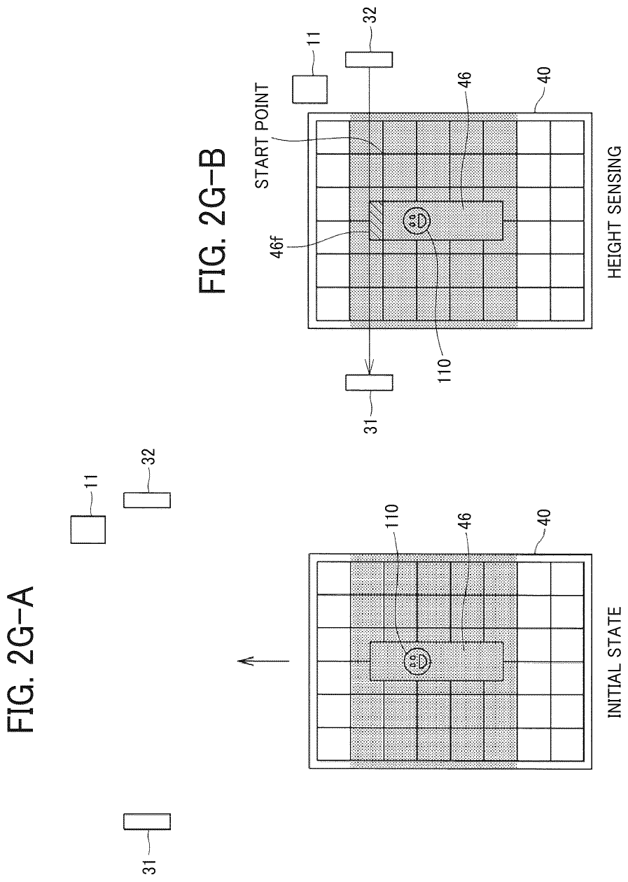

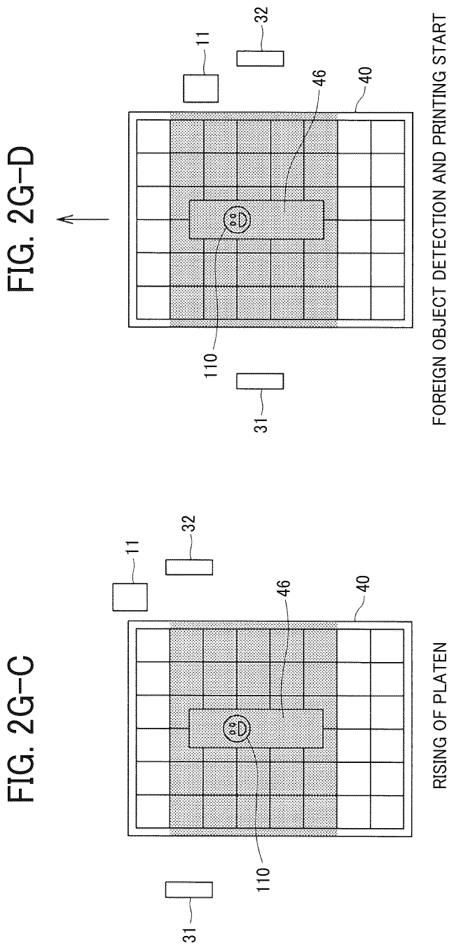

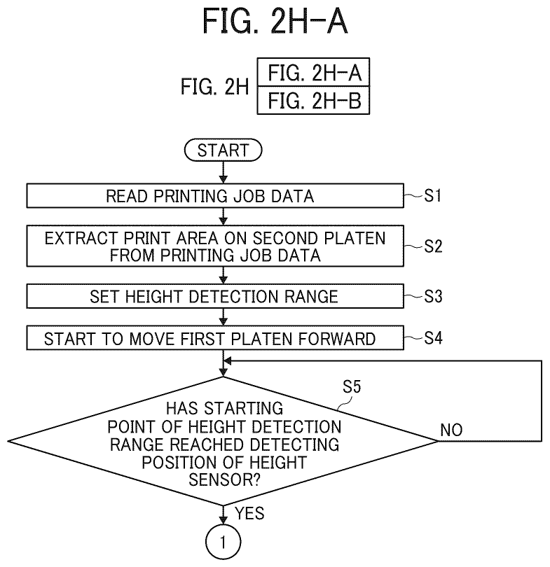

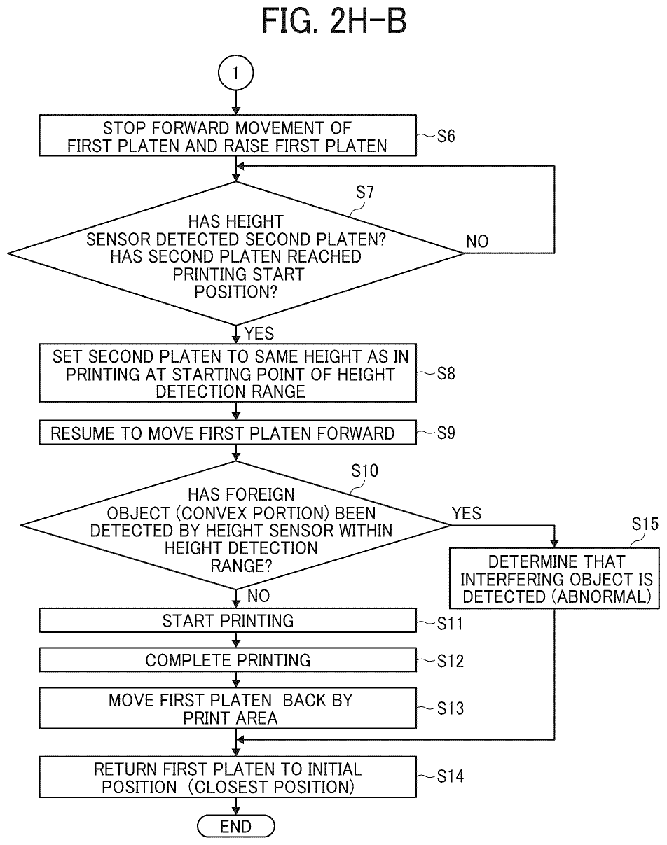

A configuration of a printing apparatus 1 according to a first embodiment will be described with reference to FIGS. 1A to 2H. FIG. 1A is a perspective view of the printing apparatus. FIG. 1B is a plan view of the printing apparatus 1. FIG. 1C is a front view of the printing apparatus 1.

As illustrated in FIG. 1C, the printing apparatus 1 includes a carriage 11 equipped with a head 10 serving as a liquid discharger that discharges liquid. The liquid is discharged from a nozzle 10a of the head 10 toward a printing object (e.g., a cloth 400 in FIG. 1C) below. The printing object is set on a first platen 40 described below.

As illustrated in FIGS. 1A and 1B, the carriage 11 is slidably held by a rear guide member 12 and a front guide member 13 that are arranged in a main scanning direction, which is indicated by arrow X in FIGS. 1A, 1B, and 1C, and in parallel to each other. On the near side of the front guide member 13, a transverse frame 2, which forms a machine frame and has an inverted U-shape when viewed from the front, is disposed. The carriage 11 is movable in the horizontal direction (main scanning direction X) by an X-axis timing belt 17.

As illustrated in FIG. 1C, a driving pulley 15 and a driven pulley 16 are disposed at both ends of the printing apparatus 1 in the main scanning direction X. The X-axis timing belt 17 is wound around the driving pulley 15 and the driven pulley 16.

As illustrated in FIG. 1B, the X-axis timing belt 17 is rotationally driven by the driving pulley 15 being rotated by the main scanning motor 14. The carriage 11 is connected to the X-axis timing belt 17. By driving the main scanning motor 14 to rotate in the forward direction or the reverse direction, the carriage 11 can be slidably moved along the rear guide member 12 and the front guide member 13 in the main scanning direction X.

As illustrated in FIG. 1A, an encoder sheet 18 is arranged along the main scanning direction X in the printing apparatus 1. The encoder sheet 18 is provided with periodic slits.

The carriage 11 has a reading sensor for reading the slits of the encoder sheet 18. The position of the carriage 11 in the main scanning direction X can be detected from the reading result of the reading sensor. A controller board 50 controls the discharging ink, which is an example of liquid, from the head 10 such that the head 10 discharges the ink at a proper position, based on the position of the carriage 11 obtained from the reading result of the reading sensor.

As illustrated in FIG. 1C, four heads 10 are mounted on the carriage 11. Each of the heads 10 includes two rows of nozzles on a nozzle surface of the head 10.

The carriage 11 is provided with a sub-tank that temporarily stores liquid to be supplied to each head 10. A liquid of desired color is supplied from a main tank 21 to the sub tank via a supply tube by a liquid feed pump.

The printing apparatus 1 includes an elevating mechanism 41 for the first platen 40, which is mounted on a slider 42. The printing apparatus 1 includes a slider rail 43 on which the slider 42 is movably mounted. The slider rail 43 extends along a sub-scanning direction indicated by arrow “Y” in FIGS. 1A and 1B. The sub-scanning direction Y is orthogonal to the main-scanning direction X. Thus, the slider 42 moves along the slider rail 43 in the sub-scanning direction Y. The elevating mechanism 41 and the slider 42 constitute at least part of a mover that moves the first platen 40 horizontally and vertically.

The slider 42 is reciprocally movable in the sub-scanning direction Y by a sub-scanning drive mechanism via a Y-axis timing belt 45. By reciprocating the slider 42 in the sub-scanning direction Y, the first platen 40 is also reciprocated in the sub-scanning direction Y.

The printing apparatus 1 includes a maintenance unit 60 to maintain and recover a discharging performance of the heads 10. The maintenance unit 60 is disposed on one end (right end in FIG. 1C) of the printing apparatus 1 in the main-scanning direction X. The maintenance unit 60 includes a suction cap 61, a moisture-retention cap 62, and a wiper 63. The suction cap 61 caps the nozzle surface of the head 10. The moisture-retention cap 62 caps the nozzle surface of the head 10 to keep moisture in the nozzles of the head 10. The wiper 63 wipes the nozzle surface of the head 10. The suction cap 61 is coupled to a suction pump serving as a suction device.

The printing apparatus 1 includes a discharge receptacle 66 on another end (left end in FIG. 1C) of the printing apparatus 1 in the main-scanning direction X. The controller board 50 controls the head 10 to discharge the liquid to the discharge receptacle 66 during printing to maintain and recover the discharge performance of the head 10. Further, the printing apparatus 1 includes a power button 70, an operation device 71, a power supply 72, and the like.

In the printing apparatus 1, when a printing operation is performed on a cloth (an object to be printed) such as a T-shirt, the cloth is set on the first platen 40. Thereafter, the operation device 71 is operated to completely pull the first platen 40 into the rear of the apparatus via the slider 42.

When the first platen 40 is fully (completely) pulled into the printing apparatus 1, the printing apparatus 1 turns to a print-data standby state. The printing apparatus 1 starts a printing operation when the printing apparatus 1 receives print data from an external information processing device, such as a computer. Alternatively, when print data such as image data of the one-point image is previously stored in the controller board 50, the printing apparatus 1 may receive the print data by selection through the operation device 71 to start the printing operation.

When the printing apparatus 1 starts the printing operation, the printing apparatus 1 moves the slider 42 to move the first platen 40 to a printing start position. Then, the printing apparatus 1 moves the carriage 11 while discharging liquid from the head 10 to perform one line of printing on the cloth 400.

When the printing apparatus 1 prints the one line, the printing apparatus 1 moves the slider 42 to move the first platen 40 by one line. The printing apparatus 1 repeats one scan of the carriage 11 and intermittent movement of the slider 42 to perform printing on a desired area of the cloth 400. The printing apparatus 1 moves the first platen 40 back to the front side of the printing apparatus 1, as illustrated position in FIG. 1B, and then the printing operation is finished.

### First Platen and Second Platen

The printing apparatus 1 includes the first platen 40 as a first support to support the cloth 400 as an example of the printing object. The first platen 40 is detachably attached to the printing apparatus 1. A first flat surface is formed on the upper side of the first platen 40. The first flat surface is defined in the X and Y directions and constitutes a surface of supporting the printing object. The first platen 40 is mounted on the elevating mechanism 41, and the position of the first platen 40 is adjustable in height in the vertical direction indicated by arrow Z in FIGS. 1A and 1C.

As illustrated in FIG. 1C, the printing apparatus 1 includes a height sensor that detects the height of the printing object such as the cloth 400 on the first platen 40,. The height sensor may be, for example, a transmission type photoelectric sensor including a light emitter 31 and a light receiver 32 disposed on inner side faces of the transverse frame 2 on the front guide member 13 for guiding the carriage 11. The height sensor may be a reflection type photoelectric sensor 10b including one or more light emitter-receiver units disposed between the heads 10 on the lower surface of the carriage 11.

Before printing is performed on the printing object, the height of the printing object relative to the head 10 can be detected in advance by the height sensor. This prevents the carriage 11 and the head 10 from interfering with a raised portion such as a pocket or a button to be printed. Thus, a printing failure or a machine error can be prevented.

For example, if the height of the cloth 400 conveyed in the sub-scanning direction is equal to or higher than the height of the head 10, the cloth400 collides with the head 10, and thus there is a concern that a printing failure may occur. For this reason, in the operation of pulling the first platen 40 into the printing apparatus 1 before printing, when the height sensor detects that the height of the cloth400 conveyed in the sub-scanning direction is equal to or higher than the height of the head 10, that is, when there is a possibility that the cloth400 collides with the head 10, the printing apparatus 1 temporarily stops the printing operation and performs a height adjustment process of the cloth400.

The height adjustment process can be performed by the elevating mechanism 41 of the first platen 40. That is, the first platen 40 is moved up and down by the elevating mechanism 41, and thus it is possible to adjust the gap between the carriage 11 and the cloth400 to a predetermined distance. After the height adjustment process is completed, the printing operation is resumed.

As illustrated in FIGS. 2A and 2B, the first platen 40 has grooves 40a and first flat surface portions 40b as positioning portions at a plurality of predetermined positions of the first platen 40. As illustrated in FIG. 2B, the grooves 40a extend in a matrix (grid) shape in the main scanning direction X and the sub-scanning direction Y. The upper surface of the first platen 40 is divided by the grooves 40a extending in the matrix shape, into a plurality of rectangular plate-shaped portions, that is, the first flat surface portions 40b.

The groove 40a has a semi-circular arc-shaped cross section as illustrated in FIG. 2B. As illustrated in FIGS. 2C-A, 2C-B, and 2C-C, in the present embodiment, a second platen 46 has a protrusion 46a. The protrusion 46a as a positioned portion can be selectively positioned on one of the grooves 40a of the first platen 40. The second platen 46 is an example of a second support to support the printing object in an area corresponding to one of the first flat surface portions 40b defined by the grooves 40a. The cross-sectional shape of the groove 40a is not limited to a semicircular arc shape.

FIG. 2C-B is a perspective view of the second platen 46. The second platen 46 has a rectangular plate shape having a size corresponding to one of the plurality of rectangular plate portions (the first flat surface portions 40b) of the first platen 40. The second platen 46 has a thickness to support the printing object at a higher position than the first platen 40.

The shape of the second platen 46 is not limited to a rectangular plate shape (square or oblong) but may be any other shape such as an elliptical shape or an L shape. The shape of the second platen 46 can be selected in accordance with the shape of the printing object or the size of the print area. In other words, a second flat surface portion that can support the printing object is formed by the upper surface of the second platen 46.

As illustrated in FIGS. 2C-B and 2C-C, the protrusion 46a, which is an example of the positioned portion, is formed at the bottoms of the four sides of the second platen 46 having a rectangular plate shape. The protrusion 46a has a semi-circular cross section and can be fitted into the grooves 40a around one of the plurality of rectangular plate-shaped portions (the first flat surface portions 40b) of the first platen 40.

One or more second platens 46 can be arranged on the first platen 40 in accordance with the print area of the printing object. The second platen 46 is disposed on any one of the first flat surface portions 40b, thus allowing the height of the first flat surface portion 40b to be raised by a predetermined height corresponding to the height of the second platen 46. The second flat surface formed by the second platen 46 is at a maximum height above the first flat surface portion 40b of the first platen 40.

FIGS. 2D-A and 2D-B illustrate a state in which printing is performed on a T-shirt 100 as a printing object using the first platen 40 and the second platen 46. FIG. 2D-A is a plan view of the T-shirt 100, illustrating a state in which a one-point image 110 as a print image is printed on the T-shirt 100. A pocket 120 and a button 130, which are raised portions of the printing object, are located below the one-point image 110.

Conventionally, a print image near such a raised portion of a cloth, such as the pocket 120 and the button 130, would be detected by a sensor, and the height of the first platen 40 would be lowered by the elevating mechanism 41. As a result, the distance between the first platen 40 and the carriage 11, which is illustrated in FIG. 1C, would be too large, thus causing a printing failure. However, in the present embodiment, since the second platen 46 can be placed below the one-point image 110, the height of the one-point image 110 is set higher than the first flat surface portion 40b of the first platen 40, by an amount corresponding to the height of the second platen 46. Therefore, the present embodiment can prevent printing defects caused by the raised portion of the printing object.

As a result of using the second platen 46, the distance between the carriage 11 and the one-point image 110 can be reduced to an appropriate distance, thus preventing printing defects. Note that a plurality of types of second platens 46 having different heights may be prepared so that one second platen 46 having an optimum height corresponding to the height of the raised portion of the printing object is selectively used.

FIG. 2E-A illustrates a display screen of an operation device 71 of the printing apparatus 1, which will be described later. The operation device 71 can be configured by, for example, a liquid crystal touch panel.

Grid lines G are displayed in the right-side area of the operation device 71. The grid lines G represent the grooves 40a illustrated in FIG. 2D-B. The one-point image 110 is displayed in a print area set in advance with reference to the grid lines G.

The image size GS (height: h mm and width: W mm) of the one-point image 110, offset values OS(X: x mm and Y: y mm) of the one-point image 110, and a print start key P are displayed in the left-side area of the operation device 71. The numerical values (h, w, x, and y) of the image size GS and the offset values OS (print position) can be set using, for example, a numeric keypad when the size and position of the one-point image 110 are finely adjusted. After the image size and the offset values are determined, the printing can be started by pressing the print start key P.

FIG. 2E-B illustrates an example of a hardware configuration of a controller 80 of the printing apparatus 1 according to the present embodiment. The controller 80 is mounted inside the main body of the printing apparatus 1, and has a hardware configuration similar to that of an information processing terminal such as a general server computer or a PC (Personal Computer).

The controller 80 includes a central processing unit (CPU) 81, a random-access memory (RAM) 82, a read-only memory (ROM) 83, a storage device 84, and an interface (I/F) 85, which are connected via a system bus 87. The display 86 and the operation device 71 are connected to the I/F 85.

The CPU 81 as processing circuitry is an arithmetic device and controls the entire operation of the printing apparatus 1. The RAM 82 is a volatile storage medium capable of reading and writing information at high speed. When the CPU 81 processes information, the RAM 82 is used as a working area of the CPU 81. The ROM 83 is a read-only nonvolatile storage medium that stores programs such as a firmware of the printing apparatus 1.

The storage device 84 is a non-volatile storage medium capable of reading and writing information, and stores an operating system (OS), various control programs, application programs, and the like. The storage device 84 is, for example, a solid-state drive (SSD) or a hard disk drive (HDD). The I/F85 connects the system bus 87 to various hardware and networks to control them.

The display 86 is a visual user interface for the user to check the state of the printing apparatus 1. The display 86 is, for example, an organic electro luminescence (EL) display or a liquid crystal display (LCD). The operation device 71 is a user interface for the user to input information to the printing apparatus 1. The operation device 71 may include input devices, such as a keyboard and a mouse. In the embodiment described in FIG. 1A, the operation device 71 of the printing apparatus 1 also has a display function of the display 86.

The hardware configuration of the controller 80 has been described above, but the hardware configuration of the controller 80 is merely one example. The controller 80 does not need to include all the components illustrated in FIG. 2E-B or may include other components.

Designation of Print area

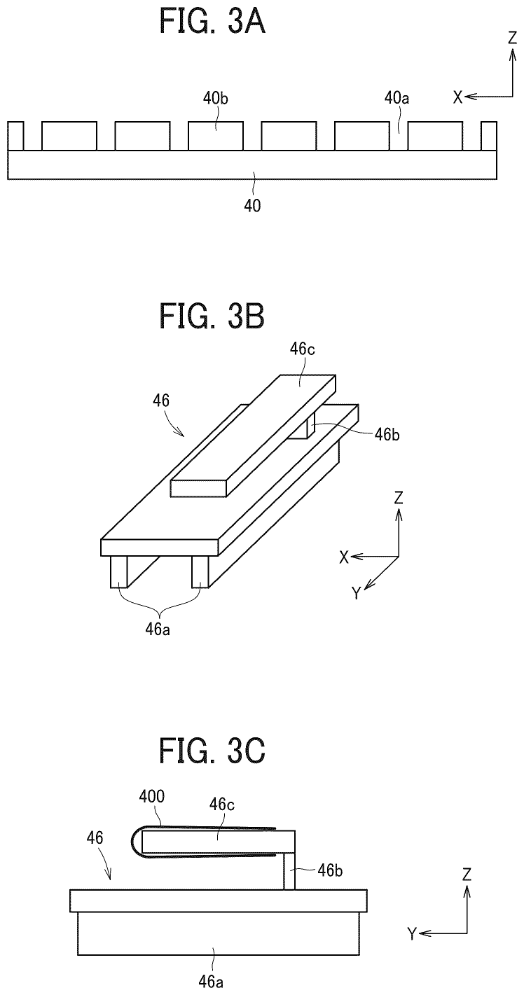

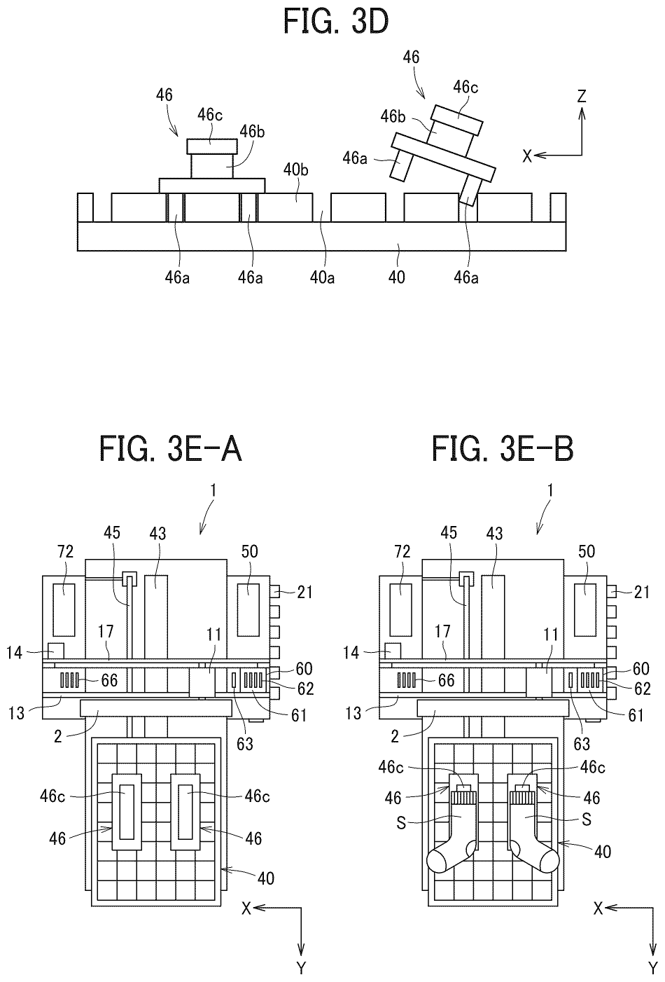

Next, the designation of a print area by print job data will be described with reference to FIGS. 2F-A to 2F-C. First, as illustrated in FIG. 2F-A, the second platen 46 of FIG. 3B is disposed on the center of the first platen 40. On the second platen 46, a print region for the printing object, i.e., the one-point image 110 for the T-shirt in FIG. 2F-A is placed.

FIGS. 2F-B and 2F-C are conceptual diagrams illustrating printing data to be written in the print job. As illustrated in FIG. 2F-B, in accordance with the print region of the one-point image 110 to be printed on the printing object (T-shirt) placed on the second platen 46, a print area (indicated by “1”) and an outside of the print area (indicated by “0”) are designated as the print area data. The print area can be designated by an external personal computer (PC) which operates in conjunction with the operation device 71.

In the display screen of the operation device 71, indicating the grooves 40a of the first platen 40 by the grid lines G allows the position of the second platen 46 placed on the first platen 40 to be easily recognized visually as illustrated in FIG. 2E-A. That is, as illustrated in FIG. 2F-B, a grid of m rows and n columns corresponding to the grooves 40a in the matrix shape can be formed on the first platen 40. Accordingly, the grid can be displayed as grid lines G on the operation device 71, thus allowing the print area to be easily confirmed on the operation device 71. The grid lines G can be formed by application software installed in the controller 80 or the external PC connected to the printing apparatus 1.

Next, as illustrated in FIGS. 2E-A, the printing position of an image to be printed can be accurately designated using the image size GS and the offset OS (the printing position). Based on the designation of the printing position, each area in the grid is determined to be the print area or the outside of the print area, and for example, as illustrated in 2F-C, the print area and the outside of the print area can be set to “1” and “0”, respectively.

Then, the setting information is stored in the print job data. The print job data is stored in the storage device 84 of the controller 80 as illustrated in FIG. 2E-B.

A printing operation after storing the setting information in the print job data is described based on conceptual figures of FIGS. 2G-A to 2G-D and a flowchart illustrated in FIG. 2H including FIG. 2H-A and FIG. 2H-B.

In the present embodiment, the printing operation is managed and controlled by the CPU 81 with execution of various control programs stored in RAM 82 and ROM 83 of the controller 80.

In the printing operation, first, a print area is extracted and determined from information on the print area (e.g., data indicated by “1” or “0” as illustrated in FIG. 2F-C) stored for each grid in the printing job data. Then, the height detection of the second platen 46 and the height position adjustment of the first platen 40, which are printing preparation steps, are performed.

### Movement of the First Platen

Next, the movement of the first platen 40 in the printing preparation steps will be described with reference to FIGS. 2G-A to 2G-D. Here, for simplicity, it is assumed that only one second platen 46 illustrated in FIG. 3B is disposed at the center of the first platen 40. An initial state (FIG. 2G-A), sensing of the height of the second platen 46 (FIG. 2G-B), raising of the first platen (FIG. 2G-C), and detection of foreign objects and start of printing (FIG. 2G-D) will be described in order.

FIG. 2G-A illustrates the initial state of the printing operation. In the initial state, the second platen 46 for supporting the print area of the printing object (such as the T-shirt 100) is positioned on the first platen 40, and the first platen 40 is positioned at a starting point in the sub-scanning direction. In this initial state, the first platen 40 and the second platen 46 are at the lowest position of the printing apparatus 1.

The shaded areas illustrated in FIGS. 2G-A to 2G-D, such as a grid of 5 rows by 6 columns, indicate a height detection range of the height sensor including the light emitter 31 and the light receiver 32 in a plan view. The carriage 11 moves in the main scanning direction, that is, the left-right direction orthogonal to the sub-scanning direction of the first platen 40. Therefore, for detecting a convex portion or an interfering object which becomes an obstacle to the movement of the carriage 11, the height detection range of the height sensor includes a region in which the second platen 46 is placed, and a region of the second platen 46 in the main scanning direction.

From the initial state illustrated in FIG. 2G-A, the first platen 40 starts to move forward in the sub-scanning direction indicated by the arrow. Then, as illustrated in FIG. 2G-B, when a front end 46f of the second platen 46 reaches between the light emitter 31 and the light receiver 32, the forward movement of the first platen 40 is stopped once.

In this stopped state, the height of the second platen 46 is read with the light emitter 31 and the light receiver 32. Since the front end 46f of the second platen 46 is a start point of the print area, the height of the front end 46f is set as a reference of the height sensing.

As illustrated in FIG. 2G-C, based on the results of reading the height by the light emitter 31 and the light receiver 32, the height of the first platen 40 is adjusted by the elevating mechanism 41 so that the height of the second platen 46 becomes a predetermined height suitable for printing. Thus, the distance between the head 10 and the second platen 46 is optimized.

Next, as illustrated in FIG. 2G-D, the first platen 40 is moved forward in the sub-scanning direction to the printing start position. During this forwarding movement, it is determined whether there is a foreign object in the height detection range of the light emitter 31 and the light receiver 32, with reference to the height of the second platen 46 which is optimized in height.

When it is determined that “there is no foreign object,” the actual printing operation is started. After the printing operation is completed, the first platen 40 is returned to the initial position in the sub-scanning direction as illustrated in FIG. 2G-A. When it is determined that “a foreign object is present,” it is determined that an interfering object is detected, so called “abnormal status,” and the printing operation is interrupted. Then, the first platen 40 is returned to the initial position illustrated in FIG. 2G-A

### Control Flowchart

A control flowchart of the first platen 40 during printing preparation and printing operation is illustrated in FIGS. 2H-A and 2H-B. First, the print job data described in FIG. 2F-C is read into the PC that operates in conjunction with the controller 80 of FIG. 2E-B (step S1 of FIG. 2H-A). Then, the print area on the second platen 46 is extracted from the print job data (step S2 of FIG. 2H-A).

Next, the height detection range of the light emitter 31 and the light receiver 32 has been set based on the print job data (step S3 of FIG. 2H-A). Then, the first platen 40 starts to move forward in the sub-scanning direction (step S4 of FIG. 2H-A). When the first platen 40 moves forward to the position illustrated in FIG. 2G-B, it is determined whether the starting point of the height detection range has reached the detection position of the height sensor including the light emitter 31 and the light receiver 32 (step S5 of FIG. 2H-A).

The values of the height detection range of the light emitter 31 and the light receiver 32 are set according to the height of the second platen 46 in the printing operation. In this case, the values of the height detection range can be set with a permissible range.

When it is determined that the starting point of the height detection range has reached the detection position of the height sensor (including the light emitter 31 and the light receiver 32), the first platen 40 stops the forward movement and is lifted up by the elevating mechanism 41 (step S6 of FIG. 2H-B). While the first platen 40 is rising, it is determined whether the height sensor has detected the second platen 46 and whether the second platen 46 has reached the printing start position. (step S7 of FIG. 2H-B). When the determination is “Yes”, the second platen 46 is set to the same height as the printing operation at the start point of the height detection range (step S8 of FIG. 2H-B).

Thereafter, the first platen 40 resumes to move forward (step S9 of FIG. 2H-B). Then, within the height detection range, it is determined whether a foreign object (convex portion) is detected by the height sensor (step S10 of the FIG. 2H-B). When no foreign object is detected, the printing operation is started (step S11 of FIG. 2H-B), and when the printing operation is completed (step S12 of FIG. 2H-B), the first platen 40 is moved back by the print area (step S13 of FIG. 2H-B). Then, the first platen 40 is further retracted to return to the initial position (step S14 of FIG. 2H-B)

When a foreign object is detected in the height detection range, it is determined as the abnormal status that an interfering object is detected (step S15 of FIG. 2H-B). Then, the first platen 40 returns to the initial position without performing the printing operation (step S14 of FIG. 2H-B).

### Second Embodiment

Next, a first platen 40 and a second platen 46 of a printing apparatus according to a second embodiment will be described with reference to FIGS. 3A to 3E. In the second embodiment, as illustrated in FIG. 3A, grooves 40a of the first platen 40 are formed to have a rectangular shape in cross section.

As illustrated in FIG. 3B, a pair of protrusions 46a as positioned portions of the second platen 46 are formed in a rectangular shape to be able to be fitted into the rectangular shape of the grooves 40a. The pair of protrusions 46a are formed in parallel to each other and can be engaged with the grooves 40a, which are formed in a matrix structure, on the first platen 40 such that the second platen 46 is slidable on the first platen 40 in the X direction or the Y direction along the grooves 40a. Therefore, the position of the second platen 46 can be easily adjusted on the first platen 40.

As illustrated in FIGS. 3B and 3C, an arm 46c is disposed on an upper surface of a body of the second platen 46 via a pillar 46b. The arm 46c is formed of an elongated plate as illustrated in FIGS. 3B and 3C. One end of the arm 46c is connected to the body of the second platen 46 via the pillar 46b.

The other end of the arm 46c extends in parallel to the upper surface of the body of the second platen 46. Therefore, as illustrated in FIG. 3C, when a bag-shaped cloth 400, which is an example of the printing object, can be put on and supported by the arm 46c of the second platen 46. That is, a second flat surface capable of supporting the printing object is formed by the upper surface of the arm 46c.

As illustrated in FIG. 3D, the pair of protrusions 46a of the second platen 46 are fitted into the grooves 40a of the first platen 40, and thus the second platen 46 can be positioned at any position on the first platen 40. The second platen 46 can be used suitably when a design such as a one-point image is printed on a printing object that is smaller than the first platen 40 and is likely to be wrinkled, such as a sock or a bag.

That is, a sock, a bag, or the like can be easily set on the second platen 46. Therefore, it is possible to easily prevent the printing object from being wrinkled.

FIGS. 3E-A and 3E-B illustrate a state in which socks S are put on two second platens 46 positioned in this way, and ink is discharged from the head 10 mounted on the carriage 11 onto the socks S to print a predetermined pattern on the surface of each of the socks S. Since the carriage 11 can be moved to any position on the X-Y plane on the first platen 40, the second platen 46 may be placed at any position on the first platen 40. As illustrated in FIGS. 3E-A and 3E-B, for reducing the movement range of the carriage 11 to enhance the printing efficiency, the second platens 46 are placed relatively close to each other in the X direction and the coordinates of the second platens 46 in the Y direction are aligned with each other.

As illustrated in FIG. 3E-B, the socks S are attached to the arms 46c of the pair of second platens 46, which are placed on the right side and the left side of the first platen 40. That is, the arms 46c are inserted into the openings of the socks S.

A pattern such as a one-point image is printed on the surface of a body part on the lower side of the opening of each of the socks S. At this time, the sock S is attached to the arm 46c such that the arm 46c is positioned and supported under the pattern such as the one-point image. In the state illustrated in FIG. 3E-B, the carriage 11 of the printing apparatus 1 is operated to print the pattern such as the one-point image on the body part of the sock S.

The number of second platens 46 placed on the first platen 40 can be increased when the first platen 40 has a sufficiently large size. Alternatively, in a case where the size of the first platen 40 is small, only one second platen 46 may be placed on the first platen.

### Third Embodiment

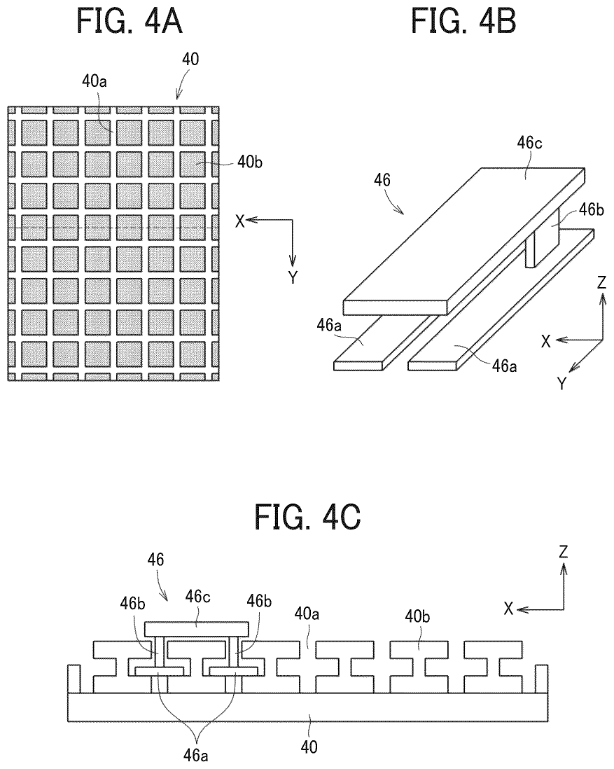

Next, a first platen 40 and a second platen 46 of a printing apparatus according to a third embodiment will be described with reference to FIGS. 4A and 4B. In the third embodiment, as illustrated in FIG. 4B, since the entrance side (upper side) of grooves 40a of the first platen 40 is narrowed, each of the grooves 40a is formed in an inverted “T” shape as a whole.

Further, as illustrated in FIGS. 4A and 4B, a pair of protrusions 46a and a pair of pillars 46b as positioned portions of the second platen 46 are formed in the inverted “T” shape so as to be fitted to the grooves 40a of the inverted “T” shape. The pair of protrusions 46a are formed in parallel to each other and can be engaged with the grooves 40a, which are formed in a matrix structure, on the first platen 40 such that the second platen 46 is slidable on the first platen 40 in the X direction or the Y direction along the grooves 40a. Therefore, the position of the second platen 46 can be easily adjusted on the first platen 40.

As illustrate in FIG. 4B, one end of an arm 46c is connected to the upper ends of the pair of right and left pillars 46b. In the third embodiment, since the arm 46c is supported on the pair of right and left pillars 46b, the lateral width of the arm 46c can be wider than in the second embodiment described above.

Therefore, a printing object, such as a bag, having a large width can be attached to the arm 46c, and a pattern such as a one-point image can be printed on the surface of the bag or the like without causing a printing failure. In this case, the protrusion 46a and the pillar 46b of the second platen 46 are formed in an inverted “T” shape, the protrusion 46a and the pillar 46b remains stable and does not detach from the groove 40a of the first platen 40, even when the weight of the printing object, such as a bag, is heavy.

### Fourth Embodiment

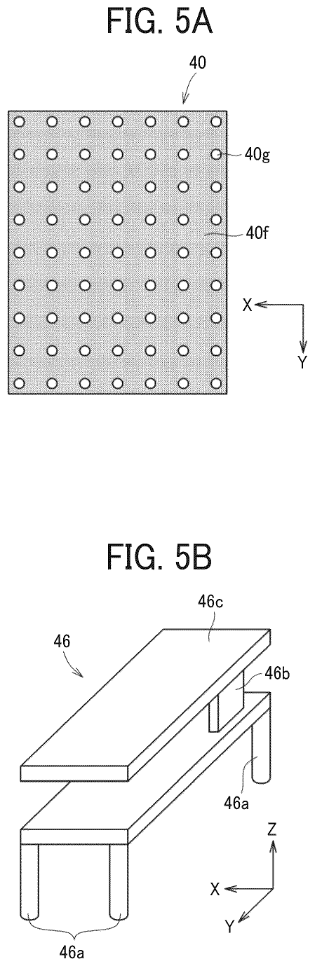

Next, a first platen 40 and a second platen 46 of a printing apparatus according to a fourth embodiment will be described with reference to FIGS. 5A and 5B. In the fourth embodiment, as illustrated in FIG. 5A, a plurality of vertical holes 40g having a predetermined depth are formed in a matrix shape in a first flat surface of the first platen 40.

In the example illustrated in FIG. 5A, the pitch between the vertical holes 40g is formed in the same distance in both the X direction and the Y direction, but the pitch may be different in the X direction and the Y direction. Regions 40f, each whose upper, lower, left, and right sides are defined by four vertical holes 40g constitute on the first flat surface of the first platen 40 for supporting a printing object.

On the other hand, as illustrated in FIG. 5B, four cylindrical protrusions 46a as positioned portions are formed at four corners of the lower surface of a body of the second platen 46 so as to be able to fit into the four vertical holes 40g of the first platen 40. The four protrusions 46a can be engaged with four vertical holes 40g at any position on the first platen 40.

An arm 46c of the second platen 46 is connected to the body of the second platen 46 via pillars 46b, as in the second and third embodiments described above. Therefore, the arm 46c can be inserted into a printing object, such as a sock or a bag, and a design such as a one-point image can be printed on the surface of the printing object. The pillars 46b may be a pair of right and left pillars, or one sturdy pillar may be employed instead of a plurality of pillars.

### Fifth Embodiment

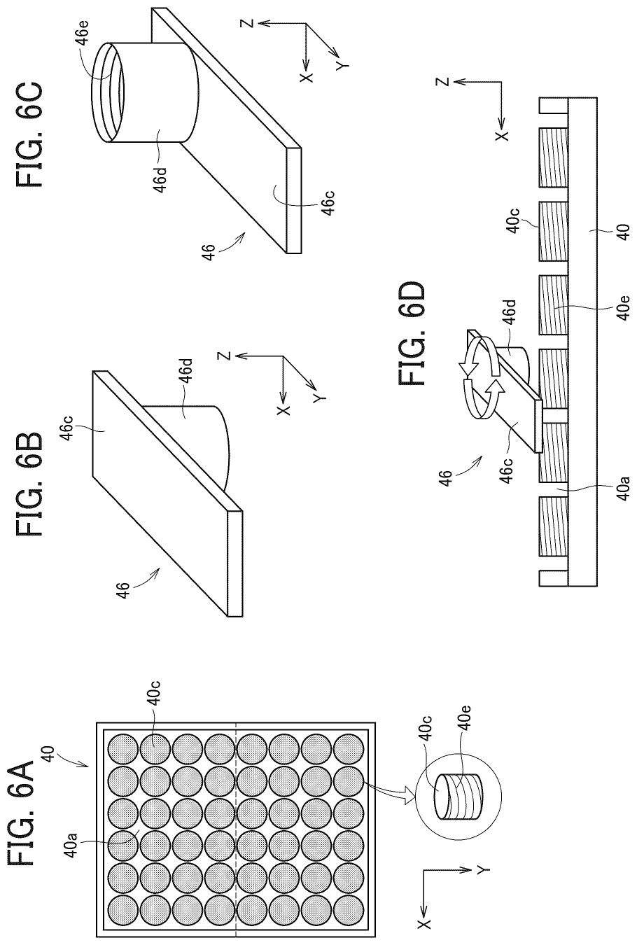

Next, a first platen 40 and a second platen 46 of a printing apparatus according to a fifth embodiment will be described with reference to FIGS. 6A and 6C. In the fifth embodiment, as illustrated in FIG. 6A, a plurality of short cylindrical column 40c are formed in a matrix shape on an upper side of the first platen 40. The short cylindrical column 40c constitutes a cylindrical boss, and the upper surface of the short cylindrical column 40c, serving as the cylindrical positioning portion, constitutes the first flat surface for supporting a printing object. As illustrated in FIG. 6A, grooves 40a that are formed among the short cylindrical columns 40c do not have the function of positioning the second platen 46.

As illustrated in FIG. 6B, a short cylindrical portion 46d as a positioned portion is formed on the lower surface of an arm 46c of the second platen 46 so as to be able to fit into the short cylindrical column 40c of the first platen 40. The short cylindrical portion 46d can be engaged with or positioned on any one of the short cylindrical columns 40c of the first platen 40 such that the cylindrical portion 46d covers the one cylindrical portion 46d.

As illustrated in FIG. 6D, a male screw 40e can be formed on an outer peripheral surface of the short cylindrical column 40c of the first platen 40. On the other hand, a female screw 46e can be formed on an inner peripheral surface of the short cylindrical portion 46d of the second platen 46. Then, the female screw 46e of the short cylindrical portion 46d is screwed to the male screw 40e of the short cylindrical column 40c, and thus the short cylindrical portion 46d can be positioned to the short cylindrical column 40c.

Further, when the second platen 46 is rotated in a direction indicated by an arrow in FIG. 6D (clockwise or counterclockwise), the height of the arm 46c of the second platen 46 can be adjusted to increase or decrease with respect to the upper surface of the short cylindrical column 40c serving as the first flat surface of the first platen 40. Thus, the height of the arm 46c of the second platen 46 can be adjusted to increase or decrease in accordance with the height of the printing object, such as the pocket 120 or the button 130 of the T-shirt illustrated in FIG. 2D-A.

Further, when a pattern such as a one-point image is printed on the surface of a pocket or bag portion formed in a part of the printing object, the pattern can be printed in a state where the arm 46c is inserted into the pocket or bag portion in order to prevent printing defects due to the occurrence of wrinkles. At this time, even in a case where it is difficult to change the orientation of the printing object on the first platen 40, the second platen 46 can be rotated in accordance with the orientation of an opening of the pocket or bag portion. Thus, the arm 46c can be inserted smoothly. Further, in order to prevent the direction of the arm 46c of the second platen 46 from easily swinging, the male screw 40e and the female screw 46e may be fitted with a moderate degree of tightness.

In each of the embodiments described above, the first platen 40 and the second platen 46 that support a cloth as the printing object can be detached and moved to the fixing step after the printing operation is completed. In other words, from the viewpoint of workability, it is desirable that the first platen 40 and the second platen 46 supporting a cloth can be detached from the printing apparatus 1, and moveable to a heating device that fixes a printed image.

Further, in the above-described embodiments, the case where the printing object is a cloth is described, but the printing object is not limited to a cloth. The above-described embodiments can be similarly applied to a case where a printing object other than a cloth is set on the first platen 40 and the second platen 46 and printing is performed.

The printing apparatus 1 may be configured as an image forming apparatus that discharges ink to form an image on a print medium, or a three-dimensional modeling apparatus that discharges a modeling liquid onto a powder layer formed of layers of powder.

The printing apparatus 1 is not limited to an apparatus in which a significant image such as a character or a figure is visualized by the discharged liquid. For example, the apparatus includes an apparatus that forms a pattern or the like that does not have a meaning in itself, and an apparatus that shapes a three-dimensional image.

Further, examples of the printing object include an object to which liquid can adhere at least temporarily, such as an object to which liquid adheres and sticks, and an object to which liquid adheres and permeates. Examples of the “object to which liquid can adhered at least temporarily” include recording media, such as paper sheet, recording paper, recording sheet of paper, film, and cloth, electronic component, such as electronic substrate and piezoelectric element, and media, such as powder layer, organ model, and testing cell. The “object to which liquid can adhere at least temporarily” includes any material on which liquid is adhered, unless particularly limited.

The material of the printing object may be any material to which liquid can be temporarily attached, such as paper, thread, fiber, cloth, leather, metal, plastic, glass, wood, or ceramic.

The carriage 11 may be configured to move a discharger that discharges liquid relative to the printing object. Therefore, examples of the printing apparatus include a line type apparatus in which the discharger is not moved, in addition to a serial type apparatus in which the discharger is moved.

Examples of the discharger that discharges liquid include a treatment liquid applier that applies a treatment liquid on the surface of a printing object for the purpose of modifying the surface of the printing object.

As described above, according to at least one embodiment of the present disclosure, the height of a printing object in a print area can be adjusted in a simple manner by means of a second support arranged on a first support. By disposing the second support on the first support, a second flat surface can be provided in accordance with the shape, size, or thickness of the printing object, and the occurrence of a printing failure due to wrinkles or a raised portion of the printing object can be reduced.

Hereinafter, aspects of the present disclosure will be supplementarily described.

### First Aspect

A printing apparatus includes: a first support having a first flat surface to support a printing object, the first support including a plurality of positioning portions at a plurality of positions of the first flat surface; and a second support having a second flat surface to support the printing object. The second support includes a positioned portion to be positioned on any one of the plurality of positioning portions with the second flat surface being higher than the first flat surface.

### Second Aspect

In the printing apparatus according to the first aspect, the plurality of positioning portions of the first support are arranged in a matrix in the first flat surface.

### Third Aspect

In the printing apparatus according to the second aspect, the plurality of positioning portions of the first support are grooves arranged in the matrix. The first flat surface includes a plurality of rectangular plate portions defined by the grooves.

### Fourth Aspect

In the printing apparatus according to the second aspect, the plurality of positioning portions of the first support are a plurality of columnar bosses arranged in the matrix, and upper circular surfaces of the plurality of columnar bosses are arranged in the first flat surface.

### Fifth Aspect

In the printing apparatus according to any one of the first to fourth aspects, the second support has the positioned portion and at least another positioned portion that are to be positioned on at least two of the plurality of positioning portions.

### Sixth Aspect

In the printing apparatus according to the third aspect, the second support has a rectangular plate shape having a size corresponding to each of the plurality of rectangular plate portions of the first support. The positioned portion of the second support is a protrusion to fit into grooves around any one of the plurality of rectangular plate portions, among the grooves of the first support arranged in the matrix, and the protrusion is disposed under four sides of the rectangular plate shape of the second support.

### Seventh Aspect

In the printing apparatus according to the fourth aspect, the positioned portion of the second support is a cylindrical positioned portion to fit into any one of the plurality of columnar bosses of the first support.

### Eighth Aspect

In the printing apparatus according to the seventh aspect, the first support includes a male screw on an outer peripheral surface of each of the plurality of columnar bosses. The second support includes a female screw on an inner peripheral surface of the cylindrical positioned portion. The cylindrical positioned portion of the second support is rotated to screw the male screw and the female screw together to position the cylindrical positioned portion on any one of the plurality of columnar bosses.

### Ninth Aspect

In the printing apparatus according to the first aspect, the second support includes a body and a pillar, and one end of the second flat surface is connected to the body via the pillar.

### Tenth Aspect

The printing apparatus according to the first aspect further includes a carriage having a liquid discharger, the carriage being movable horizontally above the first support; a mover to move the first support horizontally and vertically; and a height sensor to detect a height of the printing object on the first support. A distance between the carriage and the printing object is adjustable with the mover that moves the first support vertically based on a detection result of the height with the height sensor.

### Eleventh Aspect

The printing apparatus according to the tenth aspect further includes a display to display a print area based on the detection result of the height sensor.

### Twelfth Aspect

In the printing apparatus according to the eleventh aspect, the display displays a print image and the print area based on the detection result of the height sensor.

### Thirteenth Aspect

In the printing apparatus according to the twelfth aspect, the positioned portion of the second support is positioned on any one of the plurality of positioning portions of the first support such that the second flat surface is placed in a region of the first flat surface of the first support, the region corresponding to the print image and the print area.

The above-described embodiments are illustrative and do not limit the present embodiment. Thus, numerous additional modifications and variations are possible in light of the above teachings. For example, elements and/or features of different illustrative embodiments may be combined with each other and/or substituted for each other within the scope of the present embodiment.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and circuit components arranged to perform the recited functions.

1. A printing apparatus comprising:
a first support having a first flat surface to support a printing object, the first support including a plurality of positioning portions at a plurality of positions of the first flat surface; and
a second support having a second flat surface to support the printing object, the second support including a positioned portion to be positioned on any one of the plurality of positioning portions with the second flat surface being higher than the first flat surface.

2. The printing apparatus according to claim 1,
wherein the plurality of positioning portions of the first support are arranged in a matrix in the first flat surface.

3. The printing apparatus according to claim 2,
wherein the plurality of positioning portions of the first support are grooves arranged in the matrix, and the first flat surface includes a plurality of rectangular plate portions defined by the grooves.

4. The printing apparatus according to claim 2,
wherein the plurality of positioning portions of the first support are a plurality of columnar bosses arranged in the matrix, and upper circular surfaces of the plurality of columnar bosses are arranged in the first flat surface.

5. The printing apparatus according to claim 1,
wherein the second support has the positioned portion and at least another positioned portion that are to be positioned on at least two of the plurality of positioning portions.

6. The printing apparatus according to claim 3,
wherein the second support has a rectangular plate shape having a size corresponding to each of the plurality of rectangular plate portions of the first support,
the positioned portion of the second support is a protrusion to fit into grooves around any one of the plurality of rectangular plate portions, among the grooves of the first support arranged in the matrix, and
the protrusion is disposed under four sides of the rectangular plate shape of the second support.

7. The printing apparatus according to claim 4,
wherein the positioned portion of the second support is a cylindrical positioned portion to fit into any one of the plurality of columnar bosses of the first support.

8. The printing apparatus according to claim 7,
wherein the first support includes a male screw on an outer peripheral surface of each of the plurality of columnar bosses, the second support includes a female screw on an inner peripheral surface of the cylindrical positioned portion, and the cylindrical positioned portion of the second support is rotated to screw the male screw and the female screw together to position the cylindrical positioned portion on any one of the plurality of columnar bosses.

9. The printing apparatus according to claim 1,
wherein the second support includes a body and a pillar, and one end of the second flat surface is connected to the body via the pillar.

10. The printing apparatus according to claim 1, further comprising:
a carriage having a liquid discharger, the carriage being movable horizontally above the first support;
a mover to move the first support horizontally and vertically;
a height sensor to detect a height of the printing object on the first support; and
processing circuitry configured to cause the mover to move the first support vertically, based on a detection result of the height sensor, to adjust a distance between the carriage and the printing object.

11. The printing apparatus according to claim 10,
further comprising a display to display a print area based on the detection result of the height sensor.

12. The printing apparatus according to claim 11,
wherein the display displays a print image and the print area based on the detection result of the height sensor.

13. The printing apparatus according to claim 12,
wherein the positioned portion of the second support is positioned on any one of the plurality of positioning portions of the first support such that the second flat surface is placed in a region of the first flat surface of the first support, the region corresponding to the print image and the print area.
